(19) United States
(12) Patent Application Publication
(10) Pub. No.: US 2010/0128689 A1
(43) Pub. Date: May 27, 2010

(54) APPARATUS AND METHOD FOR CONTROLLING INTERFERENCE IN A WIRELESS COMMUNICATION SYSTEM

(75) Inventors: Yeo-Joon YOON, Seoul (KR); Chae-Man LIM, Seoul (KR); Shin-Ho KIM, Suwon-si (KR); Yu-Dong BAE, Suwon-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/624,953

(22) Filed: Nov. 24, 2009

(30) Foreign Application Priority Data
Nov. 27, 2008 (KR) 10-2008-0118682

(51) Int. Cl. H04W 72/00; H04B 15/00

(52) U.S. Cl. 370/329; 455/63.1

(57) ABSTRACT

An apparatus and a method for controlling interference in a wireless communication system are provided. The method includes receiving a signal of a DownLink (DL) frequency band that is adjacent to an UpLink (UL) frequency band supported by a User Equipment (UE), measuring a Received Signal Strength Indicator (RSSI) of the DL frequency band signal, comparing the measured RSSI with a threshold value, and, if the measured RSSI is less than the threshold value, limiting UL transmission.

### PRIORITY

The present application claims the benefit under 35 U.S.C. §119(a) of a Korean patent application filed in the Korean Intellectual Property Office on Nov. 27, 2008 and assigned Serial No. 10-2008-0118682, the entire disclosure of which is hereby incorporated by reference.

### BACKGROUND OF THE INVENTION

1. Field of the Invention

The present invention relates to an apparatus and a method for controlling interference in a wireless communication system. More particularly, the present invention relates to an apparatus and a method for controlling an UpLink (UL) transmit signal depending on DownLink (DL) reception sensitivity, thus controlling interference of the UL transmit signal in a DL in a User Equipment (UE) of a wireless communication system.

2. Description of the Related Art

In a Long Term Evolution (LTE) system, a wideband characteristic causes frequent spurious emission occurrence on a band corresponding to two to three times of necessary bandwidth. The spurious emission is an emission on a frequency or frequencies which are outside the necessary bandwidth and the level of which may be reduced without affecting transmission of information. A problem caused by the spurious emission, a system in which a wide guard-band cannot be secured because of congestion of a frequency band, is interference in a system having an adjacent frequency band. For example, an upper 700 MHz band currently expected to achieve fastest commercialization in the LTE system causes interference in a Public Safety (PS) band. Here, the PS band represents a frequency band allocated for a PS service, such as a disaster broadcast.

FIG. 1 is a conventional diagram illustrating frequency allocation for a 700 MHz band.

Referring to FIG. 1, a ‘C’ band of an upper 700 MHz band is allocated as an UpLink (UL) band in an LTE system and is adjacent to a PS band 100. At this time, a guard-band between the ‘C’ band and the PS band 100 is very narrow. Thus, spurious emission generated from a UL signal of an LTE User Equipment (UE) making use of the ‘C’ band causes interference in the adjacent PS band 100.

FIG. 2 is a conventional diagram illustrating an LTE UE interfering in a PS device. FIG. 3 is a conventional diagram illustrating a duplexer and a filter characteristic of an LTE UE. As illustrated in FIG. 2, a part of transmit signals 230 output from the LTE UE 200 is input to a receiver of the PS device 210 for receiving a signal of a PS band 300. However, as illustrated in FIG. 3, a problem exists in that it is difficult for the duplexer or filter 320 to cancel the interference, because a guard-band between the PS band 300 and a UL band 310 of the LTE system is very small. Accordingly, a reception sensitivity of the PS device 210 deteriorates.

Therefore, a need exists for a method for decreasing interference of a UL signal of the LTE UE in the PS band.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for controlling interference in a wireless communication system.

Another aspect of the present invention is to provide an apparatus and a method for controlling an UpLink (UL) depending on DownLink (DL) reception sensitivity, thus controlling interference of a UL transmit signal in a DL in a User Equipment (UE) of a wireless communication system.

A further aspect of the present invention is to provide an apparatus and a method for controlling UL transmit power depending on DL reception sensitivity of a specific frequency band, thus canceling DL interference in a UE of a wireless communication system.

Yet another aspect of the present invention is to provide an apparatus and a method for limiting a UL resource allocation position depending on DL reception sensitivity of a specific frequency band, thus canceling DL interference in a UE of a wireless communication system.

In accordance with an aspect of the present invention, a method of a UE for interference control in a wireless communication system is provided. The method includes receiving a signal of a DL frequency band that is adjacent to a UL frequency band supported by the UE, measuring a Received Signal Strength Indicator (RSSI) of the DL frequency band signal, comparing the measured RSSI with a preset threshold value, and, if the measured RSSI is less than the preset threshold value, limiting UL transmission.

In accordance with another aspect of the present invention, an apparatus of a UE for interference control in a wireless communication system is provided. The apparatus includes a receiving path and a Radio Frequency (RF) Integrated Circuit (IC). The receiving path receives a signal of a DL frequency band that is adjacent to a UL frequency band supported by the UE. The RF IC compares an RSSI of the DL frequency band signal with a preset threshold value, and limits UL transmission based on the comparison result.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a conventional diagram illustrating frequency allocation for a 700 MHz band;

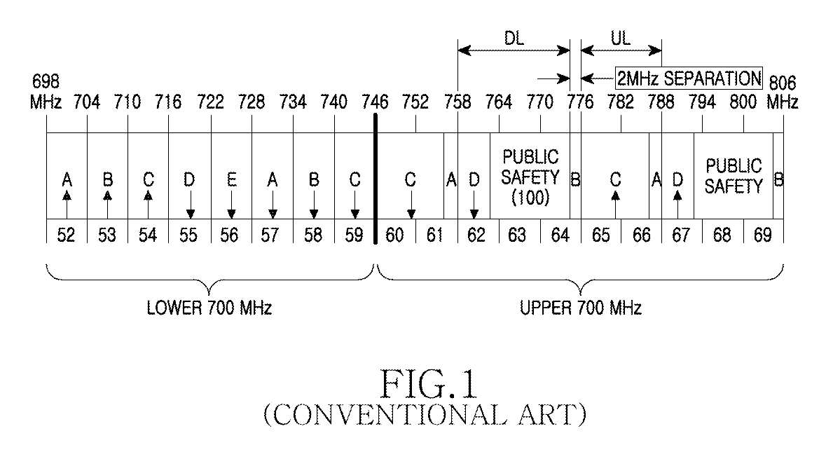

FIG. 2 is a conventional diagram illustrating a Long Term Evolution (LTE) User Equipment (UE) interfering in a Public Safety (PS) device;

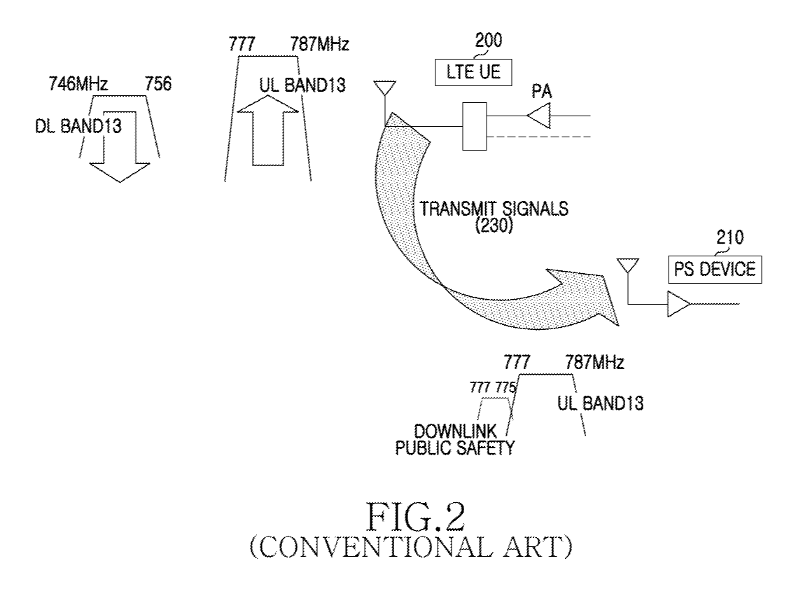

FIG. 3 is a conventional diagram illustrating a duplexer and a filter characteristic of an LTE UE;

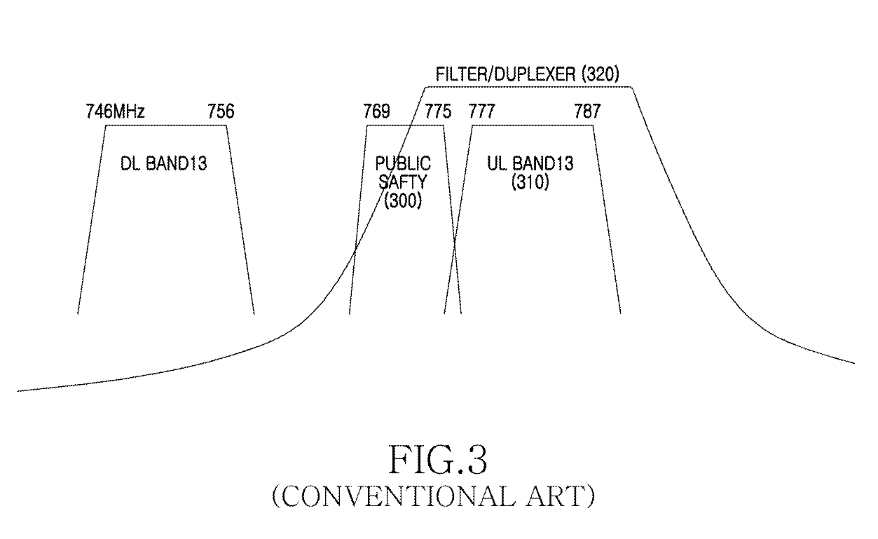

FIG. 4 is a block diagram illustrating a construction of a UE in a wireless communication system according to an exemplary embodiment of the present invention;

FIG. 5 is a diagram illustrating a filter characteristic in a wireless communication system according to an exemplary embodiment of the present invention;

FIG. 6 is a diagram illustrating a reception sensitivity measurement of a specific frequency band during a specific duration in a UE of a wireless communication system according to an exemplary embodiment of the present invention;

FIG. 7 is a flow diagram illustrating an operation procedure of a UE in a wireless communication system according to an exemplary embodiment of the present invention;

FIG. 8 is a flow diagram illustrating an operation procedure of a UE in a wireless communication system according to an exemplary embodiment of the present invention; and

FIG. 9 is a flow diagram illustrating an operation procedure for limiting UpLink resource allocation in a UE of a wireless communication system according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention provide an apparatus and a method for controlling an UpLink (UL) transmit signal depending on DownLink (DL) reception sensitivity of a specific frequency band, thus controlling interference of the UL transmit signal in a DL in a User Equipment (UE) of a wireless communication system.

In the following description, an exemplary embodiment of the present invention describes a UL band of a Long Term Evolution (LTE) system and a Public Safety (PS) band adjacent to the UL band, for example, and is identically applicable to other UL bands and DL bands adjacent to the UL bands. Also, an exemplary embodiment of the present invention describes an LTE UE not supporting a PS band, for example. However, the LTE UE may also support the PS band. That is, an LTE UE receives a signal of a PS band, does not decode the received signal of the PS band and provide the decoded signal to a user. Alternatively, the LTE UE may decode the received signal of the PS band and provide the decoded signal to the user.

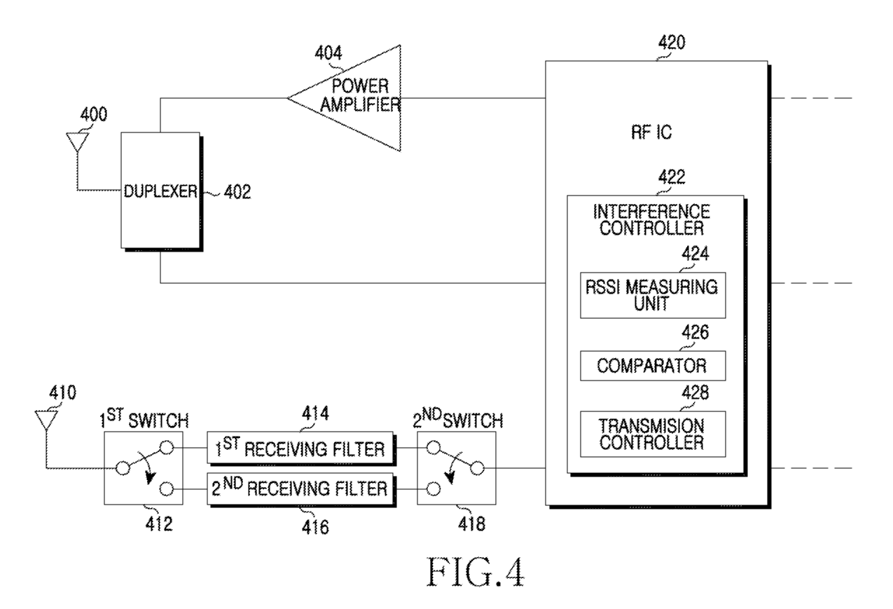

FIG. 4 illustrates a construction of a UE in a wireless communication system according to an exemplary embodiment of the present invention. As illustrated in FIG. 4, the UE includes a first antenna 400, a duplexer 402, a power amplifier 404, a second antenna 410, a first switch 412, a first receiving filter 414, a second receiving filter 416, a second switch 418 and a Radio Frequency (RF) Integrated Circuit (IC) 420. The RF IC 420 includes an interference controller 422. The interference controller 422 includes a Received Signal Strength Indicator (RSSI) measuring unit 424, a comparator 426 and a transmission controller 428.

Referring to FIG. 4, the duplexer 402 transmits a transmit signal, which is provided from the RF IC 420 through the power amplifier 404, through the first antenna 400 according to a duplexing scheme. The duplexer 402 provides a receive signal from the first antenna 400 to the RF IC 420.

The power amplifier 404 amplifies, by a high power, a transmit signal from the RF IC 420, and outputs the amplified signal to the duplexer 402.

The first switch 412 performs a switching operation depending on a control signal provided from the RF IC 420 and provides a receive signal from the second antenna 410 to the first receiving filter 414 or the second receiving filter 416.

The first receiving filter 414 receives a receive signal from the second antenna 410 through the first switch 412 and passes a signal corresponding to a preset first frequency band. Here, the first receiving filter 414 passes a signal of a DL frequency band of the wireless communication system supported by the UE. That is, if the UE is equal to an LTE UE, the first receiving filter 414 passes a signal of a DL frequency band supporting the LTE system.

The second receiving filter 416 receives a receive signal from the second antenna 410 through the first switch 412 and passes a signal corresponding to a preset second frequency band. Here, the second receiving filter 416 passes a signal of a DL frequency band adjacent to a UL frequency band of the wireless communication system supported by the UE.

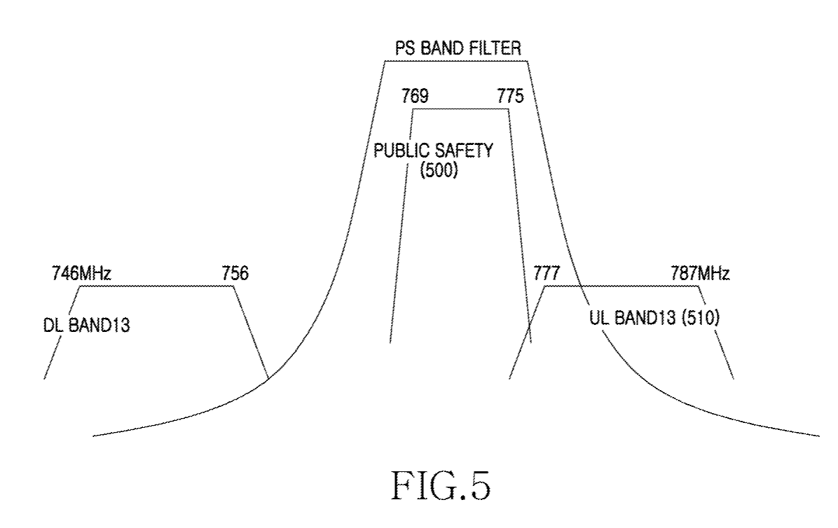

FIG. 5 is a diagram illustrating a filter characteristic in a wireless communication system according to an exemplary embodiment of the present invention.

Referring to FIG. 5, if the UE is equal to an LTE UE, as illustrated in FIG. 5, the second receiving filter 416 passes a signal of a PS band 500 adjacent to a UL frequency band 510 of the LTE system.

Referring back to FIG. 4, the second switch 418 performs a switching operation depending on a control signal provided from the RF IC 420 and provides the receive signal, from the first receiving filter 414 or second receiving filter 416, to the RF IC 420.

The RF IC 420 performs a function of processing a transmit signal and receive signal of the UE. The RF IC 420 includes the interference controller 422 and performs a function of controlling a UL depending on reception sensitivity of a signal corresponding to a second frequency band and canceling interference of the UL in the second frequency band.

That is, the interference controller 422 includes the RSSI measuring unit 424, the comparator 426, and the transmission controller 428. The interference controller 422 measures an RSSI corresponding to the second frequency band every predefined period or every predefined gap duration, compares the measured RSSI with a preset threshold value, and determines if its own UL signal interferes in the second frequency band. The interference controller 422 then performs a UL control depending on the determination result. Here, if the UE is in an idle state, the interference controller 422 measures a receive signal for the second frequency band every predefined period. If the UE is in a connect state, the interference controller 422 measures a receive signal for the second frequency band every predefined gap duration scheduled in an Access Point (AP) and performs the UL control operation. At this time, when the UE is in a call connect state in the wireless communication system, the gap duration may be either a signal measurement duration repeated every 40 ms or 60 ms for an inter-frequency or inter-Radio Access Technology (inter-RAT) handover or may be a gap duration separately scheduled for an interference cancelation for the second frequency band.

In more detail, the interference controller 422 outputs a control signal to the first switch 412 and the second switch 418 every predefined period or every predefined gap duration scheduled for the interference cancelation in the AP and controls the first switch 412 and the second switch 418 to connect with the second receiving filter 416. Upon receiving a signal corresponding to the second frequency band by connecting the first switch 412 and the second switch 418 with the second receiving filter 416, the interference controller 422 measures an RSSI of the receive signal using the RSSI measuring unit 424. At this time, the RSSI measuring unit 424 measures carrier RSSI for the second frequency band.

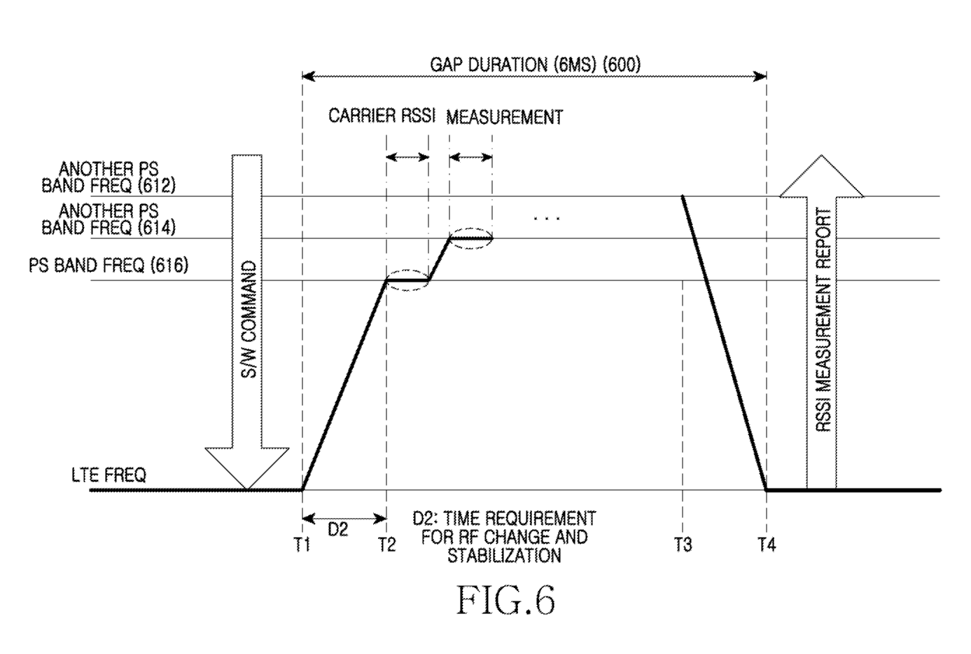

FIG. 6 is a diagram illustrating a reception sensitivity measurement of a specific frequency band during a specific duration in a UE of a wireless communication system according to an exemplary embodiment of the present invention.

Referring to FIG. 6, the RSSI measuring unit 424 measures an RSSI by carrier 612, 614 or 616 for a PS band, which is a second frequency band, during a predefined gap duration 600 provided from an AP.

In FIG. 4, if an RSSI is measured by carrier for the second frequency band through the RSSI measuring unit 424, the interference controller 422 compares the measured carrier RSSI with a threshold value using the comparator 426. If there is one RSSI that is less than the threshold value, the interference controller 422 determines that its own UL signal interferes in the second frequency band and limits a UL transmit power or limits a UL resource allocation position using the transmission controller 428. Also, in a state where the interference controller 422 limits the UL transmit power or limits the UL resource allocation position, if there is not one RSSI that is less than the threshold value as a comparison result of the comparator 426, the interference controller 422 releases the limiting operation in execution.

A description has been made above of a structure for adding two switches and two bandpass filters to a path for receiving a first frequency band signal of a UE and thus, receiving a second frequency band signal with reference to FIG. 4. However, the receiving path may be a path for the second frequency band signal or an additional path for receiving the second frequency band signal may be provided. In this case, the UE may periodically receive the second frequency band signal irrespective of a connect state of the UE. That is, although the UE is in the connect state, the UE may receive the second frequency band signal and thus, the UE may measure an RSSI of the second frequency band signal without using a gap duration for measuring an RSSI for the inter-frequency or inter-RAT handover.

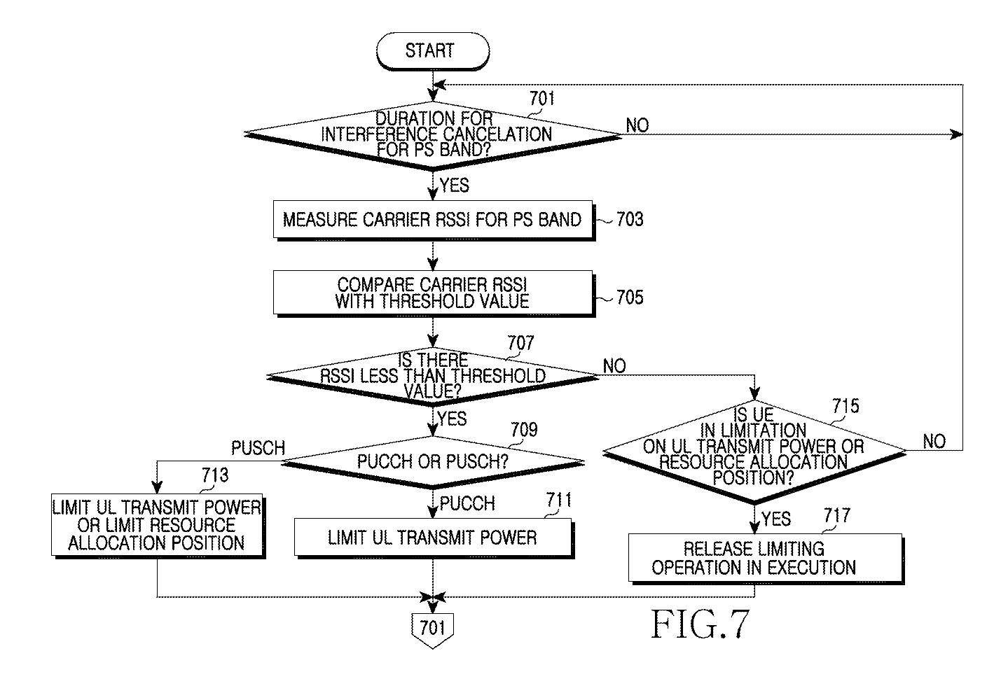

Thus, an operation procedure of a UE measuring an RSSI every predefined period or every predefined gap duration set in an AP and thus controlling a UL is described below with reference to FIGS. 7 to 9. The following description is made assuming herein that the first frequency band is equal to a DL band of an LTE system and the second frequency band is equal to a PS band.

FIG. 7 is a flow diagram illustrating an operation procedure of a UE in a wireless communication system according to an exemplary embodiment of the present invention. Here, if a DL signal of an LTE system and a PS band signal by the same path are received, the UE performs an operation for interference cancelation for the PS band during a predefined gap duration scheduled in an AP.

Referring to FIG. 7, in step 701, the UE determines whether there is a gap duration for interference cancelation for a PS band. Here, the gap duration for interference cancelation for the PS band, which is a duration scheduled for interference cancelation in the AP, is received according to need or periodically from the AP.

When there is a gap duration for interference cancelation for the PS band, the UE measures carrier RSSI for the PS band in step 703 and then compares the measured carrier RSSI with a threshold value in step 705.

In step 707, the UE then determines if the RSSI is less than the threshold value. When the RSSI is less than the threshold value, the UE determines whether to currently transmit on a Physical Uplink Control CHannel (PUCCH), whether it is in transmission on a Physical Uplink Shared CHannel (PUSCH), or whether to transmit on the PUSCH in step 709. Here, the PUCCH is a channel for transmitting control information, such as a Hybrid Automatic Repeat Request (HARQ) ACKnowledgment (ACK)/Negative ACK (NACK) signal, a scheduling request signal, a Channel Quality Indicator (CQI), and the like. The PUSCH is a channel for transmitting information on an UpLink-Shared CHannel (UL-SCH).

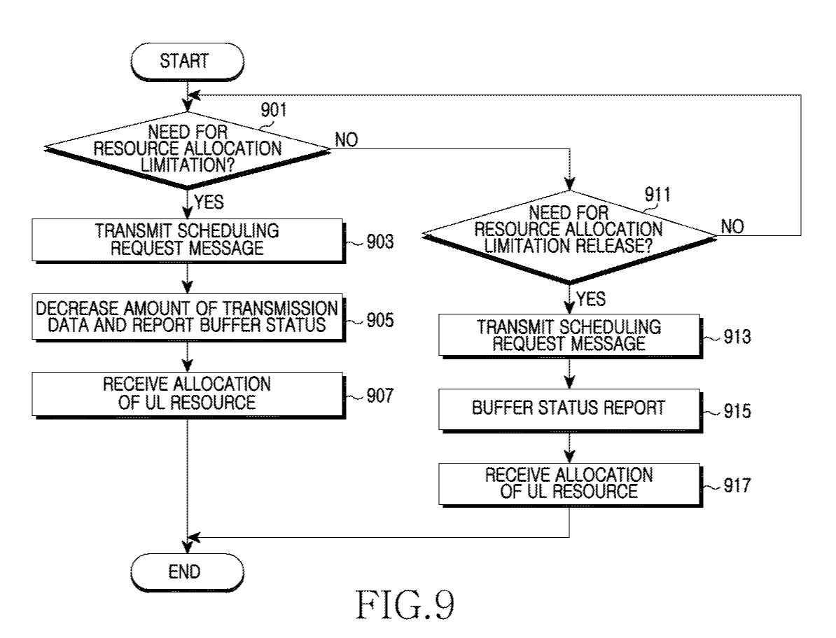

If the UE is transmitting on the PUCCH, the UE limits a UL transmit power in step 711 and then returns to step 701. On the other hand, if the UE is transmitting on the PUSCH, the UE performs an operation for limiting a UL transmit power or limiting a resource allocation position in step 713, and then returns to step 701. Here, the operation for limiting the resource allocation position is described below in more detail with reference to FIG. 9.

On the other hand, when the RSSI is not less than the threshold value, the UE determines if it is in limitation on a UL transmit power or a resource allocation position in step 715. If the UE is in limitation on the UL transmit power or the resource allocation position, the UE releases the in-execution limiting operation in step 717 and then returns to step 701. Otherwise, the UE directly returns to step 701 and again performs the subsequent steps. The operation for releasing the resource allocation position limitation is described below in more detail with reference to FIG. 9.

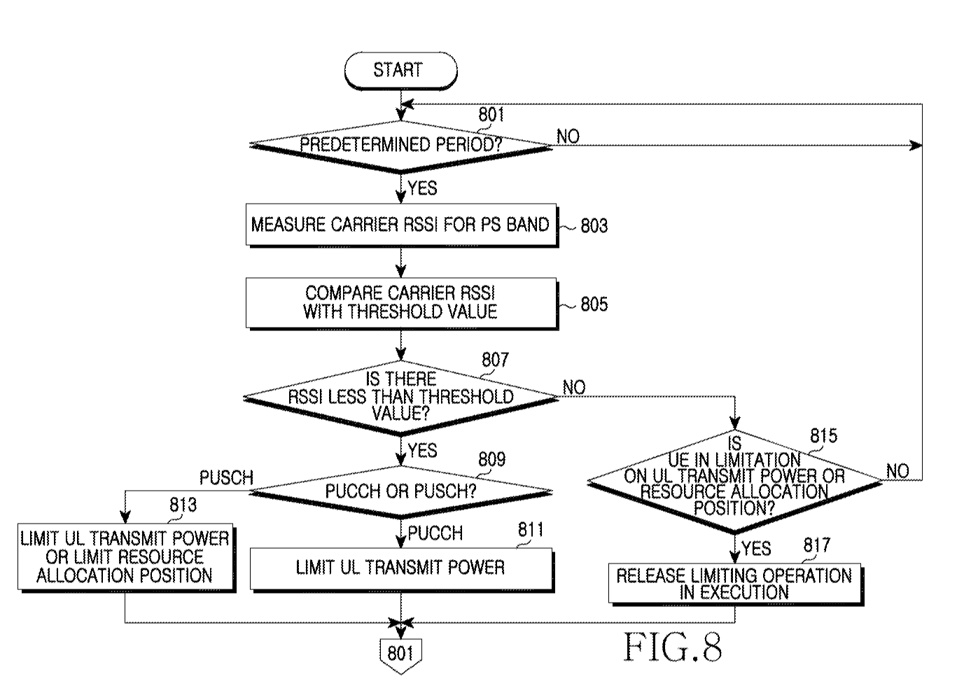

FIG. 8 is a flow diagram illustrating an operation procedure of a UE in a wireless communication system according to an exemplary embodiment of the present invention. Here, if the UE has a path for receiving only a PS band, the UE performs an operation for interference cancelation for the PS band every predefined period, irrespective of an idle state and connect state of the UE.

Referring to FIG. 8, in step 801, the UE determines if there is a predefined period for interference cancelation for a PS band. When there is a predefined period for interference cancelation for the PS band, the UE measures carrier RSSI for the PS band in step 803. The UE then compares the measured carrier RSSI with a threshold value in step 805.

In step 807, the UE determines if the RSSI is less than the threshold value. When the RSSI is less than the threshold value, the UE determines whether to currently transmit on a PUCCH, whether it is in transmission on a PUSCH or whether to transmit on the PUSCH in step 809. Here, the PUCCH is a channel for transmitting control information, such as a HARQ ACK/NACK signal, a scheduling request signal, a CQI, and the like. The PUSCH is a channel for transmitting information on a UL-SCH.

If transmitting on the PUCCH, the UE limits a UL transmit power in step 811 and then returns to step 801. On the other hand, if transmitting on the PUSCH, the UE performs an operation for limiting a UL transmit power or limiting a resource allocation position in step 813 and then returns to step 801. Here, the operation for limiting the resource allocation position is described below in more detail with reference to FIG. 9.

When the RSSI is not less than the threshold value, the UE determines if it is in limitation on a UL transmit power or a resource allocation position in step 815. If being in limitation on the UL transmit power or the resource allocation position, the UE releases the limiting operation in execution in step 817 and returns to step 801. Otherwise, the UE directly returns to step 801 and again performs the subsequent steps. The operation for releasing the resource allocation position limitation is described below in more detail with reference to FIG. 9.

FIG. 9 is a flow diagram illustrating an operation procedure for limiting a UL resource allocation in a UE of a wireless communication system according to an exemplary embodiment of the present invention.

Referring to FIG. 9, in step 901, the UE determines if there is a need for resource allocation position limitation. If there is a need for resource allocation position limitation, the UE transmits a scheduling request message for requesting UL resource allocation to an AP in step 903. The UE then transmits a buffer status report message representing an amount of information intending for transmission to the AP in step 905. At this time, the UE reduces the amount of information intending for transmission and reports the reduced amount of information to the AP in order to limit a resource allocation position. The UE is then allocated a UL resource suitable to a buffer status report from the AP in step 907 and terminates the procedure according to an exemplary embodiment of the present invention.

On the other hand, if there is no need for resource allocation position limitation, the UE determines if there is a need for resource allocation limitation release in step 911. If there is a need for resource allocation limitation release, the UE transmits a scheduling request message for requesting UL resource allocation to the AP in step 913. The UE then transmits a buffer status report message representing an amount of information intended for transmission to the AP in step 915. The UE is then allocated a UL resource suitable to a buffer status report from the AP in step 917 and terminates the procedure according to an exemplary embodiment of the present invention.

Exemplary embodiments of the present invention provide a method for measuring a DL reception sensitivity of a specific frequency band. When the DL reception sensitivity is poor, a UL transmit power is decreased or a UL resource allocation position is limited. Accordingly, the system efficiency loss is minimized while a UL signal interfering in the specific frequency band in the UE of a wireless communication system is controlled.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method of a User Equipment (UE) for interference control in a wireless communication system, the method comprising:
receiving a signal of a DownLink (DL) frequency band that is adjacent to an UpLink (UL) frequency band supported by the UE;
measuring a Received Signal Strength Indicator (RSSI) of the DL frequency band signal;
comparing the measured RSSI with a threshold value; and
if the measured RSSI is less than the threshold value, limiting UL transmission.

2. The method of claim 1, wherein the measuring of the RSSI of the DL frequency band signal is performed at least one of every predefined period to the UE and every predefined gap duration scheduled in an Access Point (AP).

3. The method of claim 1, wherein the RSSI of the DL frequency band signal is measured by carrier.

4. The method of claim 4, wherein, if the RSSI is less than the threshold value, at least one receive signal is less than the threshold value among a plurality of the RSSIs measured by carrier.

5. The method of claim 1, wherein the limiting of the UL transmission comprises limiting at least one of a UL transmission power and a UL resource allocation position.

6. The method of claim 6, wherein the limiting of the UL resource allocation position comprises:
transmitting to the AP a buffer status report message comprising an amount less than an amount of information intended for transmission; and
receiving an allocation of a UL resource dependent on a buffer status from the AP.

7. The method of claim 1, wherein the limiting of the UL transmission comprises limiting at least one of a UL transmit power and a UL resource allocation position, if the UE is to transmit on a Physical Uplink Control CHannel (PUCCH).

8. The method of claim 1, wherein the limiting of the UL transmission comprises limiting a UL transmit power, if the UE is one of in transmission on a Physical Uplink Shared CHannel (PUSCH) or to transmit on the PUSCH.

9. The method of claim 1, wherein the limiting of the UL transmission comprises releasing a UL transmission limiting operation, if the UE is in execution of the UL transmission limiting operation.

10. An apparatus of a User Equipment (UE) for interference control in a wireless communication system, the apparatus comprising:
a receiving path for receiving a signal of a DownLink (DL) frequency band that is adjacent to an UpLink (UL) frequency band supported by the UE; and
a Radio Frequency (RF) Integrated Circuit (IC) for comparing a Received Signal Strength Indicator (RSSI) of the DL frequency band signal with a threshold value, and for limiting UL transmission based on comparison result.

11. The apparatus of claim 11, wherein the RF IC measures an RSSI of the DL frequency band signal at least one of every predefined period to the UE and every predefined gap duration scheduled in an Access Point (AP).

12. The apparatus of claim 11, wherein the RF IC measures an RSSI by carrier of the DL frequency band.

13. The apparatus of claim 14, wherein, if one receive signal is less than the threshold value among a plurality of the RSSIs measured by carrier, the RF IC limits the UL transmission.

14. The apparatus of claim 11, wherein the RF IC limits at least one of a UL transmission power and a UL resource allocation position.

15. The apparatus of claim 16, wherein, in order to limit the UL resource allocation position, the RF IC controls reporting to the AP a buffer status report message comprising an amount less than an amount of information intended for transmission and receives an allocation of a UL resource dependent on a buffer status from the AP.

16. The apparatus of claim 11, wherein, if the UE is to transmit on a Physical Uplink Control CHannel (PUCCH), the RF IC limits at least one of a UL transmit power and a UL resource allocation position.

17. The apparatus of claim 11, wherein, if the UE is at least one of in transmission of a Physical Uplink Shared CHannel (PUSCH) and to transmit the PUSCH, the RF IC limits a UL transmit power.

18. The apparatus of claim 11, wherein, if the UE is in execution of a UL transmission limiting operation, the RF IC releases the UL transmission limiting operation.

19. The apparatus of claim 11, wherein the receiving path comprises:
a first switch for performing a switching operation depending on a control signal of the RF IC and for outputting a receive signal from an antenna;
a first receiving filter for receiving a receive signal from the first switch and for filtering a signal of a DL frequency band supported by the UE;
a second receiving filter for filtering the signal of the adjacent DL frequency band from the first switch; and
a second switch for performing a switching operation depending on a control signal of the RF IC and for providing to the RF IC a receive signal output from one of the first receiving filter and the second receiving filter.
